(19) United States
(12) Patent Application Publication
(10) Pub. No.: US 2006/0129746 A1
(43) Pub. Date: Jun. 15, 2006

(54) Method and graphic interface for storing, moving, sending or printing electronic data to two or more locations, in two or more formats with a single save function

(75) Inventor: Stephan S. Porter, West Palm Beach, FL (US)

Correspondence Address: HOWISON & ARNOTT, L.L.P, P.O. BOX 741715, DALLAS, TX, 75374-1715, US

(73) Assignee: ITHINK, INC.

(21) Appl. No.: 11/067,161

(22) Filed: Feb. 25, 2005

Related U.S. Application Data
(60) Provisional application No. 60/635,826, filed on Dec. 14, 2004.

(51) Int. Cl. G06F 12/00

(52) U.S. Cl. 711/100; 715/764; 715/733; 715/966

(57) ABSTRACT

A single graphic user interface enabling a computer user to store, print, back up or send an electronic file to multiple locations. The electronic file can be sent on multiple paths to multiple devices in multiple formats.

### RELATED APPLICATION

This application is a Utility Application of U.S. Patent Provisional Application Ser. No. 60/635,826, filed on Dec. 14, 2004, which is incorporated herein by reference in its entirety.

### BACKGROUND OF THE INVENTION

1. Field of the Invention

Embodiments of the present invention relate generally to software and a graphic user interface for storing electronic data in two or more locations, in two or more formats with a single “save” function. More particularly, embodiments of the present invention enable a personal computer's operating system or separate program or application, to allow a user to substantially simultaneously perform multiple saves, prints, faxes, or copies of a designated electronic file (e.g., document, graphics, video clip, etc.) with a single click of a graphic user interface (GUI) command.

2. Background of the Invention

In operating systems such as Microsoft Windows or the Machintosh Operating Systems, users create electronic files, such as documents, in word processing programs. When the user wants to save the electronic file to, for example, a disc drive, the user pulls up and clicks on the Save GUI button. The electronic file is then saved to a single predetermined location, such as a designated file location in drive C:. Next, the user may want to save the electronic file to a second predetermined location, such as a designated file in drive D:. Next, the user may want to print the same electronic file to a local printer. The user clicks the Print GUI button and is queried for the printer and the format for printing the electronic file. The user may then require that a backup copy of the electronic file be stored in yet another storage device such as a Flash memory or onto a storage device associated with a network that the user's computer is connected to or associated with. Again, the user must navigate a Save GUI button and select the appropriate storage location for filing the electronic file.

This step by step process continues until the user has sent, saved, stored, moved, and printed the electronic file to all the various needed locations. In order to save, backup and print a single electronic file, the user had to navigate at least four GUI's and click multiple Save, and Print GUI buttons. Such a technique is inefficient, cumbersome, and sometimes confusing.

What is needed is a method and GUI for performing multiple saves, prints, sends, and/or backups of an electronic file without having to navigate multiple GUIs, one for each function.

### BRIEF SUMMARY OF THE INVENTION

Embodiments of the present multiple save, print and backup GUI and system to allow a user to store an electronic file in multiple storage locations and in multiple formats by navigating a single GUI screen or window. The single GUI screen or window can also be used to initialize multiple prints of the electronic file to various different printers.

An embodiment of the present invention is generally part of a personal computing device, such as a personal computer, laptop, PDA, mobile phone or other consumer/user oriented device. The embodiment has a central processing portion that includes a microprocessor or microcontroller, a user interface device for allowing the user to enter data into the personal computing device, and a visual display for displaying information, such as text and graphic information to the user. An exemplary personal computing device is programmed to provide a graphic user interface screen or window that enables a user to set up multiple default file names, file to via the a single “click” or key press by the user. The user may save to multiple locations, print, e-mail or fax the electronic file to multiple locations via the single GUI.

Embodiments of the present multiple save GUI and system provide an efficient time saving, single GUI screen/window for storing an electronic file to multiple locations with multiple paths and in various formats.

### BRIEF DESCRIPTION OF THE DRAWINGS

The foregoing and other advantages of the invention will become more apparent upon reading the following Detailed Description of Embodiments of the Invention in conjunction and reference with the drawings.

FIG. 1 depicts an exemplary user's personal computer and possible internal and external devices that an electronic file can be sent to according to embodiments of the invention;

FIG. 2 is an exemplary Save As GUI according to an embodiment of the present invention;

FIG. 3 is another exemplary Save As GUI according to an embodiment of the present invention;

FIG. 4 is an exemplary save or backup GUI according to an embodiment of the present invention;

FIG. 5 is an exemplary print GUI according to an embodiment of the invention; and

FIG. 6 is an exemplary flow chart providing an exemplary method, software and usage of embodiments of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all reasonable modifications, equivalents, combinations and alternatives falling within the spirit and scope of the invention as defined by the appended claims.

### DETAILED DESCRIPTION OF THE INVENTION

The present invention will now be described more fully hereinafter with reference to the accompanying drawings in which preferred embodiments of the invention are shown. This invention may, however, be embodied in many different forms and should not be constructed as limited to the embodiments set forth herein; rather, these embodiments are provided so that this disclosure will be thorough and complete, and will fully convey the scope of the invention to those skilled in the art.

Embodiments of the present method and GUI for saving an electronic file in multiple locations incorporates one or more of the following means and methods. When a computer user is operating a software program, application, or computer operating system, the user may, from time to time, want to save, print, backup or send a copy of the electronic file being created or edited. The electronic file may be an electronic document resulting from usage of a word processing program or application, a spreadsheet, a picture file (e.g., jpg file), a music file (e.g., .mp3 file), a moving picture file (e.g., .mpeg file), a data file, or any other type of electronic file a user may want to save. The user may want to save the electronic file in more than one location or convert a single electronic file format into two or more different electronic file formats and subsequently save the newly created electronic files in a single location or in multiple locations. For example, the user may want to save the electronic file to a first storage location (i.e., a storage location associated with the word processing or spreadsheet program) and also Save due electronic file to a backup storage location. Saving the electronic file to a backup storage location may be done to guard against storage or memory loss at the first storage location. Additionally, a predetermined file storage location (default) can also be selected from within the program or application, operating system or stand alone program or application containing the multiple Save to functionality.

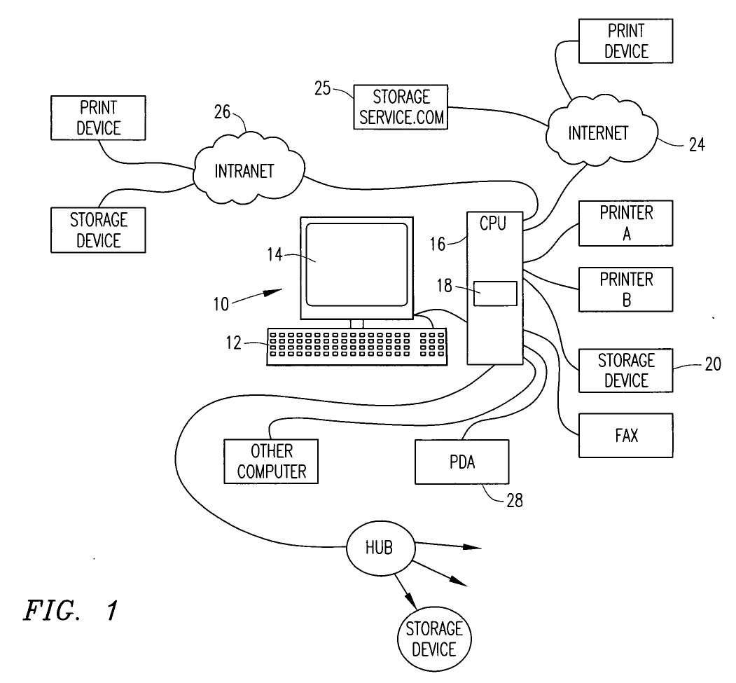

Embodiments of the present method and GUI for saving an electronic file in multiple locations saves an electronic file in two or more storage locations either substantially simultaneously (e.g., in a time sharing manner) or one right after the other. The user presets the saving parameters in the GUI. The user may click or press a single GUI save button or control button to commence the multiple storage process of the single electronic file. FIG. 1 depicts a user's personal computer 10 and a variety of peripheral storage, printing, service devices, and systems that may be connected to the personal computer 10. The personal computer 10, includes a user interface device 12, such as a keyboard. The user interface device 12 may also include a mouse, a microphone, a track ball or other device in which a user physically or orally enters information into the personal computer 10. A visual device 14, such as a display screen, is also a part of the personal computer 10. The visual device 14 provides a visual display for the user to see the graphics, windows operation of the personal computer. A central processing unit (CPU) 16 is part of the personal computer 10. The CPU 16 generally comprises a microprocessor, RAM, and ROM memories. The CPU 16 may also include a magnetic storage device 18 such as an internal magnetic or optical disk drive. The personal computer 10 may also be a single unit with the interface device 12, visual device 14 and CPU 18 included as a single unit. The personal computer 10 also may be a personal digital assistant, cell phone communication device, lap top computer, micro computer, hand-held computer or other device comprising a display, an operating system, a user interface for the use of or creation of electronic data files.

Still referring to FIG. 1, various peripheral devices may be connected, either directly or indirectly (i.e., electronically or infrared) or in communication with, the personal computing device 10. A user may want to save, copy, backup or print an electronic data file to more than one of the peripherals or other devices. For example, a user may want to save one electronic file to both an internal magnet storage device 18 and to an external storage device 20 simultaneously. The external storage device 20 may be another magnetic storage device, an optical storage device (i.e., CD ROM device), a Flash memory device, an electronic file storage location accessed via a local area network (LAN) 22, Internet 24, a wireless transmission device (e.g., radio wave, optical, sound) for sending the electronic file to another device, an intranet 26 device or any other means for storing or sending an electronic file to a storage device, printer or location. A user may also want a copy of the electronic file sent to a PDA for storage, a faxing device for forwarding the electronic file for printing or storage at another fax device.

An embodiment of the present invention comprises GUI software that is installed into a user's personal computer 10. The software may be loaded as an application running alone or in conjunction with the operating system or other software program. The exemplary embodiment can be activated by the user manually or can be pulled up by another program when the user initializes a request to save, print or backup an electronic file. For example, a user may be using the personal computer 10 as a word processor. At some point in time, the user will initialize a save function in the word processing program. The save function will incorporate an embodiment of the present invention and allow the user to select one, two or more locations for the electronic file to be saved. The user may select drive C: as well as a backup storage location (e.g., www.storage.com) on the Internet 24, 25. With a single click on a GUI save button with the mouse, keyboard or other user interface device 12, the electronic file is stored in all the selected storage locations.

An embodiment of the present invention allows for two or more navigable pathways to be utilized when an electronic file is being stored by a user in two or more locations. The electronic file may be saved and backed up to two or more locations substantially simultaneously or with data first being sent and stored to one storage location followed closely by the electronic file being sent and stored to a second storage location (without additional user intervention).

In another embodiment of the present invention, the electronic file can be sent to multiple storage locations in different formats. For example, electronic file may be stored in one storage device as a Word Perfect document file and in a second storage device as a text file.

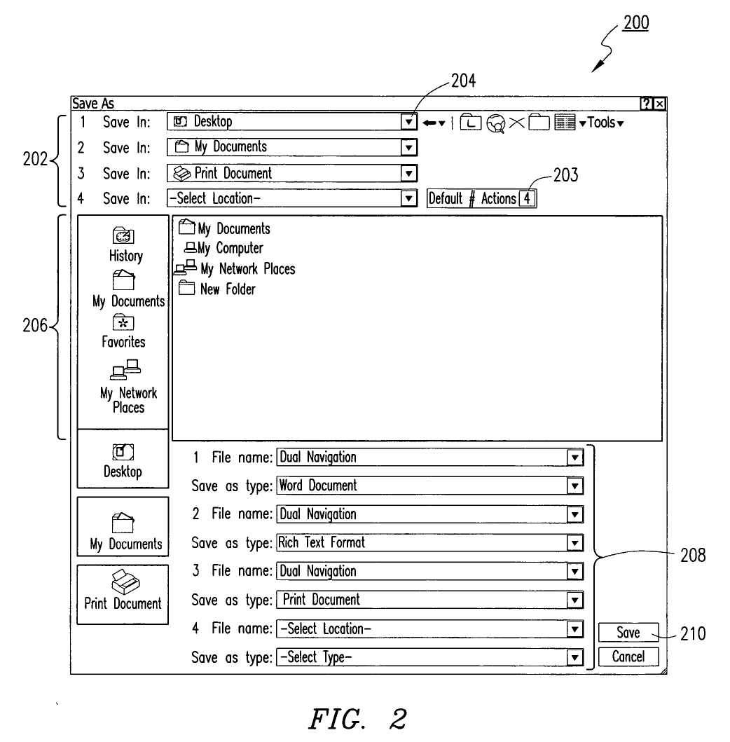

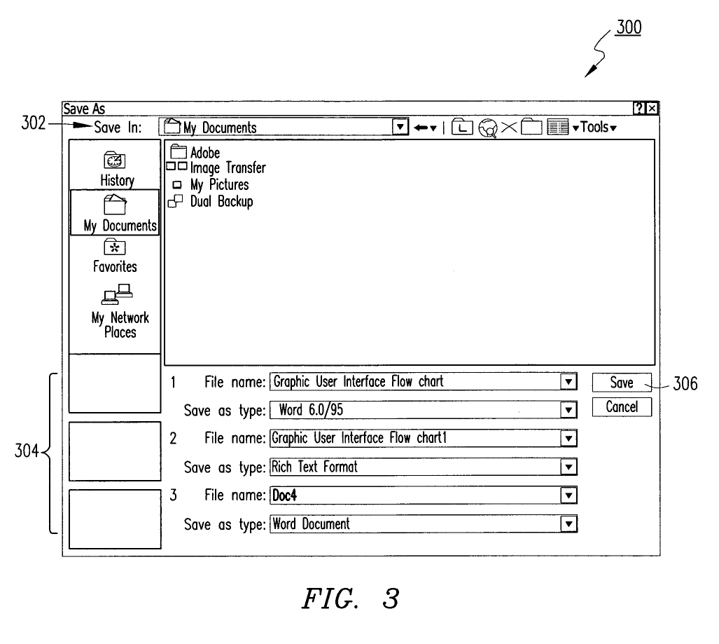

Referring to FIGS. 2 and 3, an exemplary GUI for the ‘Save As’ function or the ‘Backup’ function are provided and displayed to the user. The Save As GUI may be set up by the user in order to save an electronic file in multiple locations. In FIG. 2, an exemplary Save As GUI 200 is depicted. In the Save In area 202 of the GUI, the user can designate the file location or file path that the electronic file is to be saved in. The browse arrow 204 allows the user to browse existing storage locations. The exemplary Save As GUI 200 provides for four possible Save In locations (1-4) 202. In the exemplary Save As GUI 200, three of the four locations are designated as: (1) Desktop; (2) My Documents; and (3) Print Document. The fourth Save In location has been left blank by the user. The designated Save In locations may be either internal or external to the personal computer 10. Path or File Location browse area 206 aides and allows the user to browse possible storage or print locations for the electronic file.

The lower portion of the exemplary Save As GUI 200 provides the user the ability to designate the name and format that the saved file will have. For example, in FIG. 2, each electronic file was saved with the same name, but the formats changed. The electronic file saved in the Desktop 202-1 is saved in Microsoft Word format 208-1. The electronic file saved in the My Documents location 202-2 is saved in Rich Text format 208-2. And, the electronic file saved in the Print Document location (i.e., being printed to a designated printer) is being sent to the printer for a hard copy save (a printed version of the electronic file) in a print document format 208-3. The user clicks on the Save button 210 in the Save As GUI 200 and the electronic file is copied to the two designated locations and printed at the third designated location substantially simultaneously or in immediate succession. Furthermore, when default are set in the Save As GUI, the user need only click the Save button 210 to save the electronic file in the default plurality of places substantially simultaneously or in immediate succession.

FIG. 3 depicts another exemplary Save As GUI 300 in accordance with embodiments of the present invention. This Save As GUI 300 provides a single Save In entry 302. Thus, multiple saves designated in the File Name/Save as type section 304 are made to the same Save In file 302. Here, in FIG. 3, three files are being stored in the My Documents file 302. One file is called Graphic User Interface Chart and is being stored in a Microsoft Word 6.0/95 format 304-1; a second file is also being stored in a file called Graphic User Interface Chart, but is being stored in a text format 304-2; a third file is being stored by the name of Doc4 in a Word document format 304-3. The files will all be stored as indicated in the Save As GUI when the user clicks on the GUI Save button 306. The user may also press a designated key on the user interface keyboard (e.g., [enter]). The files are all saved or stored either substantially simultaneously or in immediate succession in the designated files having the designated format when the save button is pressed.

By using an exemplary multiple Save GUI in accordance with embodiments of the present invention, a user can save an electronic file to any number of storage locations by navigating a single, rather than multiple GUI screens or windows. Embodiments of the invention help reduce occurrences of lost data due to the ease of storing electronic files in multiple places or geographical locations on a single step. If a catastrophic loss of data occurs at a first memory location (e.g., storage 18), then the data file will remain available at a second memory location (e.g., storage device 20 or off site storage facility 25).

One of ordinary skill in the art would understand that embodiments of the present invention are not to be confused with a mirroring technique wherein data is copied from a first file to a second file when data in the first file is changed. Embodiments of the present invention provide a GUI for a user allowing the user to set up multiple saves, copies, e-mails, prints and transfers of data from a first electronic file to various locations and in various formats, as designated by a user, in a single GUI. The electronic file is copied or sent to the various designated locations in the various designated formats at the ‘click’ of a single ‘save’ or other designated command.

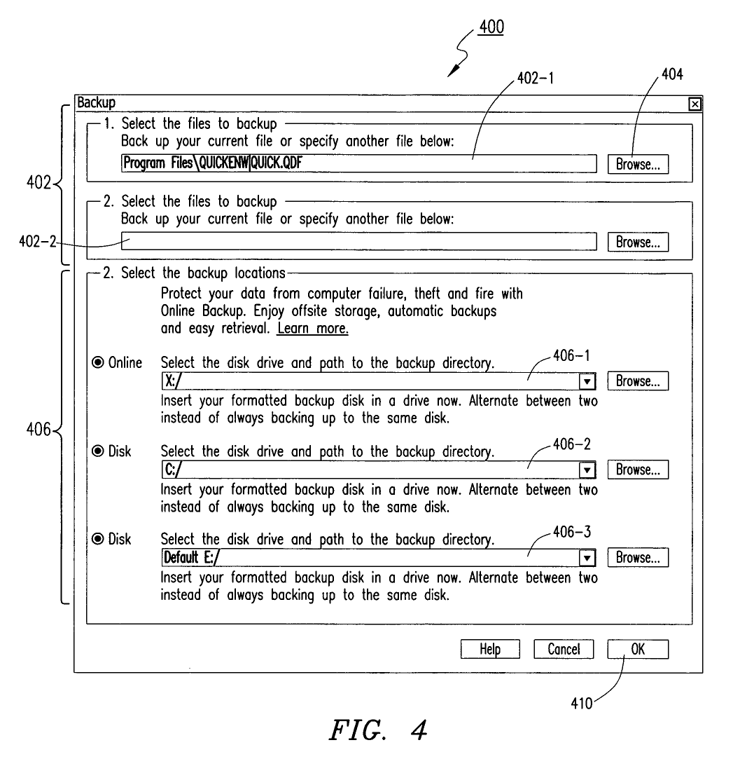

FIG. 4 depicts another exemplary GUI in accordance with embodiments of the present invention. Here a Backup GUI 400 is shown. In this exemplary embodiment, multiple electronic files can be selected and backed up to multiple storage locations. Files requiring backing-up or copying are entered in the file selection browse area 402. The file names can be typed in or the Browse feature 404 can be utilized to select the electronic file. Multiple files can be selected 402-1, 402-2. Only two selections are shown, but two or more electronic file selections can be included in an exemplary Backup GUI 400.

In the backup location portion 406, the user can select multiple locations for copying the designated electronic files 402-1, 402-2. The user enters file destinations or backup locations in locations 406-1, 406-2, 406-3. In FIG. 4 the user has selected memory locations X:/, C:/ and default E:/ as the locations for backup.

In other embodiments, the user may also select file formats in which to save the electronic files. Furthermore, e-mail addresses, fax numbers, printers and PDA electronic addresses can be entered as file destinations or backup locations 406. The single click of the Backup GUI's OK button 410 initiates saving all the electronic files to the various destinations. The selected files, 402-1, 402-2, etc., are stored, backed up or sent to the designated destination in the designated formats. The process is performed simultaneously or in a rapid immediate succession.

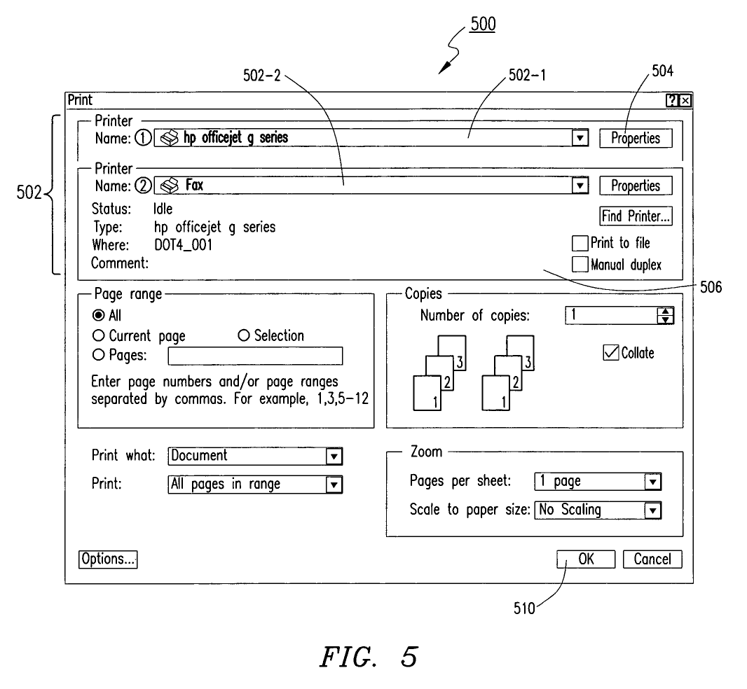

FIG. 5 depicts a Print GUI 500 in accordance with another embodiment of the present invention. In this exemplary embodiment multiple print jobs for the same electronic file are set up on a single Print GUI 500. A first print location is entered at 502-1 browser section and a second print location is entered by the user at 502-2 browser section. Other embodiments of the invention provide for more than two possible print destinations 502.

Each print destination 502-1, 502-2 has a Properties button 504 that allow the user to set up the properties of the entered print destination. In FIG. 5, the first print destination is a printer 502-1 and the second print destination is a Fax device 502-2. The remaining portions of the exemplary multiple Print GUI 500 allow the user to set the page range, number of copies and zoom of the print output. The user, after setting up the multiple Print GUI 500 clicks on “OK” 510 and the electronic file is printed to the multiple print devices and or faxed in the proper or selected formats. A user saves time by navigating a single Print GUI to achieve multiple prints of the same file in different locations executed.

It is understood that embodiments of the invention provide a single save “click” that saves, prints, e-mails, faxes, backs up, saves to an external system and/or wirelessly transfers an electronic file to multiple locations (via multiple electronic paths) as a result of a single “click” or keystroke in a user initiated GUI. Embodiments of the invention provide a means for sending an electronic file on multiple pathways in multiple formats to other designated devices. An exemplary multiple Save GUI aides in reducing occurrences of the user not backing up or forgetting to back up an electronic data file to a remote location(s).

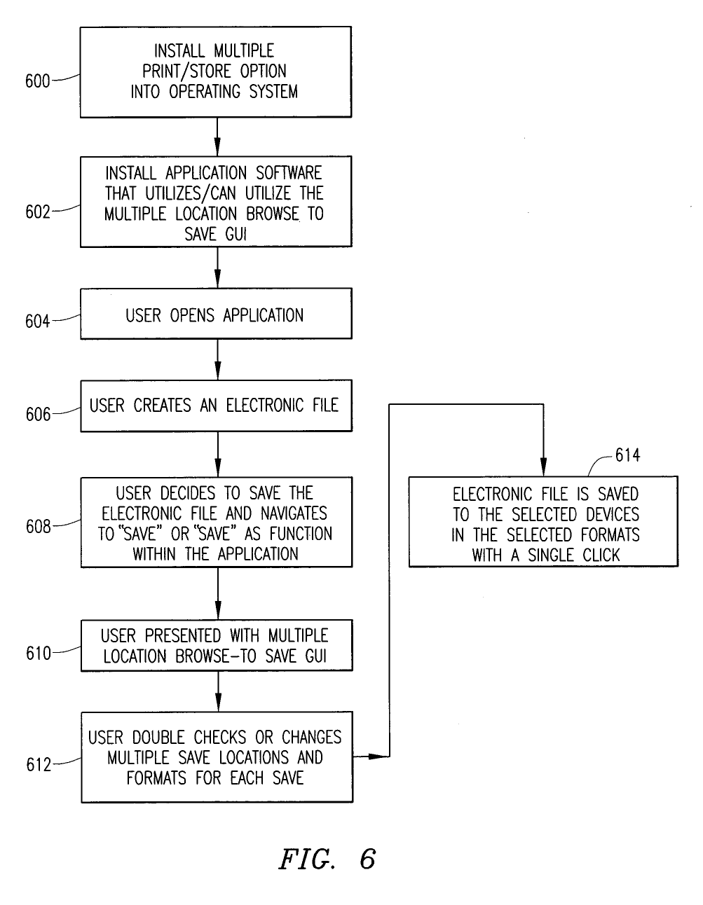

FIG. 6 depicts a flow chart for installing and using an exemplary multiple Save GUI. At step 600 the user installs the multiple Print/Store GUI and software into the operating system (OS). The user may otherwise install the multiple print GUI software in order to operate an exemplary with one or more selected programs. The user also has the option to install the exemplary multiple Save GUI and software into one or more locations such that the OS provides an option to the “control panel” or “properties” and allows the user to create and adjust the default locations for saving an electronic file when “Save” is selected while using an application or program. Additionally, a timer for automatic multiple saves or backups can be set by the user so that multiple saves, backups, faxes or e-mails are sent at specified time intervals while the user has an electronic file opened. The user may also set up the default number of browse boxes, files and/or save locations that will appear in a Save To GUI, Print GUI, or Backup GUI.

At step 602, the user may install application software, such as Microsoft Word or Microsoft Excel, that incorporates or uses an exemplary multiple location Save, Print or Backup GUI.

At step 604, the user opens an application or program that uses or incorporates an exemplary multiple location Save, Print or Backup GUI. The user may utilize options, within the application itself, to set the multiple default “Save To” location(s) that will appear in the Save As GUI when the user saves an electronic file or document. The user also may have the option within the application or program to set the number of browse boxes (1, 2, 3, 4, etc.) (202, 302, 304, 402, 406, 502) that will appear in an exemplary GUI. The user may also have an option to set a timer for a periodic save of the electronic file while the user has the electronic file opened. The periodic save saves the electronic file at the user specified time intervals to user identified multiple locations in user identified formats.

At step 606, the user creates or edits an electronic file or document in the opened application or program. The electronic file can be a document, graphic, software program, spreadsheet or substantially any electronic file that a user has access to on his/her computer, associated computer system, or network.

At step 608, the user decides to save, print or send the electronic file to multiple destinations. The user may use the Save, Save As, Print, Send, Backup or other options provided by the application in use. At step 610, the user is presented with an exemplary multiple save GUI that contains multiple browse boxes for user default save locations and/or file name and type(s). The user can navigate the single exemplary GUI to change or adjust one or more of the Save In browse boxes. The user may also adjust one or more of the file name and file type browse boxes so that the electronic file will be saved, sent to, or printed to the appropriate user selected locations with a user selected file name and in the user selected format.

The multiple location Save GUI may be set as a “pop up” screen when the “Save As” function is selected and not when a simple “Save” function is selected in the application. A user may only want to save the electronic file to a single location periodically while working on the electronic file. The user may want to perform a multiple save, print, sent, backup function at certain other times during electronic file creation, manipulation or completion.

At step 612, the user double checks and reviews the multiple save, file and type settings in the multiple Save GUI. An exemplary GUI has a button for increasing or decreasing the default number of actions 203 (see FIG. 2) to allow the user to add additional file locations for the electronic file to be saved in. The “Save In” or Save To” locations can be storage or memory locations associated with the same computer (either internal or external storage locations), off site storage locations associated to the user's computer via a wired or wireless network, internet storage locations or services, flash memory, portable memory, fax, e-mail location or other access or address of a storage device or location.

At step 614, the user need only “click” or press a single button to have the electronic file saved to multiple locations. Only a single save or print GUI is navigated by the user to perform multiple saves, backups, printouts or e-mails of the electronic file. The user does not have to navigate multiple Print, Save, Save As or other GUI windows to perform the multiple tasks. The user can set default multiple saves so that hard copies and backup saves are always created for a selected electronic file. The user is less likely to forget to backup the electronic file with the availability of a multiple Save GUI.

It is understood that there are various embodiments of the invention disclosed herein. Embodiments of the invention provide a user of personal computer, handheld computer, laptop computer, PDA, or other personal computing devices that provides a graphic screen and user interface to save an electronic file to multiple storage locations in multiple formats via a single click, button press or oral command from the user. Other embodiments provide a single GUI to save and print a single electronic file to multiple locations using a single GUI. Yet other embodiments allow a user to e-mail or fax the electronic document while printing and saving the same document after a single click or user command.

1. A personal computing device comprising:
a central processing unit (CPU) including a microprocessor;
a user interface device for entering data into said personal computing device, said user interface in electrical communication with said CPU;
a visual device for displaying graphic information to a user, said visual device in electrical communication with said CPU;
said personal computing device programmed to provide a graphic user interface (GUI), said GUI comprising a single graphic screen means for sending an electronic file to a plurality of user selected storage locations.

2. The personal computing device of claim 1, wherein said means for sending, sends said electronic file to said plurality of storage locations in one or more formats.

3. The personal computing device of claim 1, wherein said means for sending, sends said electronic file to said plurality of user selected storage locations with a single user initiated click or input to the GUI.

4. The personal computing device of claim 1, wherein GUI further comprises a plurality of Save In browse boxes for allowing said user to set said plurality of storage locations.

5. The personal computing device of claim 1, wherein said GUI further comprises a plurality of File Name and Save As Type browse boxes for allowing said user to set a file name and format that said electronic file will be stored as at said plurality of storage locations.

6. The personal computing device of claim 1, wherein said storage locations can be at least one of a magnetic storage device, an optical storage device, an electronic memory based storage device, a printer, a FAX machine, an internet based storage location, a network based storage location, and an e-mail address.

7. The personal computing device of claim 1, wherein said personal computing device comprises at least one of a personal computer, a laptop computer, a personal digital assistant, and a mobile phone device.

8. The personal computing device of claim 1, wherein said GUI is part of an operating system (OS) of said personal computing device.

9. An article of manufacture for saving an electronic file to a plurality of storage locations, said article of manufacture comprising:
a computer readable medium;
a plurality of instructions wherein at least a portion of said plurality of instructions are storable in said computer readable medium, and further wherein said plurality of instructions are configured to cause a processor to perform the steps of:
providing a multiple save graphic user interface (GUI) on a single window of a user interface device, said multiple save GUI for enabling a user to store an electronic file to a plurality of storage locations;
accepting at least a first default Save In location and a second default Save In location designated by said use on said multiple save GUI;
accepting from said user a first default File Name and a first default Save As Type for said first default Save In location;
accepting from said user a second default File Name and a second default Save As Type for said second default Save In location;
accepting a single Save input from said user;
formatting said electronic file into said first File Name having said first default Save As Type;
sending said File Name to said fist default Save In location;
formatting said electronic file into said second File Name having said second default Save As Type; and
sending said second File Name to said second default Save in location.

10. The article of manufacture of claim 9, wherein said plurality of instructions are further configured to cause the processor to perform the steps of:
accepting a default number of Save In locations from a user.

11. The article of manufacture of claim 9, wherein said plurality of instructions are further configured to cause the processor to perform the steps:
running an application program enabling a user to edit said electronic file;
opening a multiple save GUI window in response to a user's input
accepting said single Save input from said user
formatting and sending said electronic file to said first and second default Save locations, as said first and second default File Name, and in said First and Second default Save As Type, respectively.

12. The article of manufacture of claim 11, wherein said formatting and sending of said electronic file to said first and second default Save Locations is done substantially simulataneously.

13. The article of manufacture of claim 11, wherein said formatting and sending of said electronic file to said first and second default Save Locations is done substantially in immediate succession.

14. The article of manufacture of claim 9, wherein first and second Save In Location can be at least on of a magnetic memory device, an optical memory device, an electronic memory device, a FAX machine, an internet based file storage location, a network file storage location, an internet address, and an e-mail address.

15. A personal computing device comprising:
a central processing unit (CPU);
a user interface device for entering data or commands into said personal computing device, said user interface in electrical communication with said CPU;
a visual device for displaying graphic information to a user;
said personal computing device programmed to provide a multiple save graphic user interface (GUI) on said visual device, said multiple save GUI being programmed to enable a multiple save function wherein a user can initialize the sending of copies of a first electronic file to a plurality of user selected storage locations, each said copy of said first electronic file being sent to said user selected storage locations in user selected file formats and file names, said multiple save GUI including a single window or screen on said visual device and enabling a user to initiate a multiple save function with a single user input command.

16. The personal computing device of claim 15, wherein said multiple save GUI operates as part of an operating system.

17. The personal computing device of claim 15, wherein said user selected storage locations are in different file paths.

18. The personal computing device of claim 15, wherein said the number of user selected storage locations is set by said user.

19. The personal computing device of claim 15, wherein said multiple save GUI further comprises a plurality of defined area such that at least one of the defined areas comprises a user interface indicia that can be at least one of clicked on and filled in with user generated data in order to designate said plurality of user selected locations.

20. The personal computing device of claim 15, wherein said multiple save GUI is initiated by a user input in a computer software application.

21. The personal computing device of claim 1, wherein said electronic file is one of data downloaded from the internet, scanned data from a fax machine, data from an intranet, data from an external storage device, data from a data storage service, data from a wireless device, and data from another personal computing device.

22. The personal computing device of claim 1, wherein said single graphic screen means comprises a single screen GUI comprising a plurality of defined areas such that at least one of the defined areas comprises a user interface indicia that can be at least one of clicked on and filled in with user generated data in order to designate said plurality of user selected locations.

23. The article of manufacture of claim 9, wherein said electronic file is at least one of data downloaded from the internet, scanned data from a fax machine, data from an intranet, data from an external storage device, data from a data storage service, data from a wireless device, and data from a personal computing device.

24. The article of manufacture of claim 9, wherein said multiple save GUI on said single window comprises a plurality of defined areas such that at least one of the defined areas comprises a user interface indicia that can be at least one of clicked on and filled in with user generated data in order to designate said first default Save In location and said second default Save In location.

25. The personal computing device of claim 15, wherein said first electronic file comprises at least one of data downloaded from the internet, scanned data from a fax machine, data from an intranet, data from an external storage device, data from a data storage service, data from a wireless device, and data from another personal computing device.
